(19) United States
(12) Patent Application Publication
(10) Pub. No.: US 2008/0153708 A1
(43) Pub. Date: Jun. 26, 2008

(54) FATTY ACIDS AND FATTY ACID ESTERS AS HERBICIDAL AGENTS AND CARRIERS

(76) Inventor: Allen L. Jones, Clayton, NC (US)

Correspondence Address: INTELLECTUAL PROPERTY / TECHNOLOGY LAW, PO BOX 14329, RESEARCH TRIANGLE PARK, NC, 27709, US

(21) Appl. No.: 11/615,987

(22) Filed: Dec. 24, 2006

(51) Int. Cl. A01N 25/00; A01P 13/00

(52) U.S. Cl. 504/358

(57) ABSTRACT

A composition and method for killing unwanted plants using fatty acids and fatty acid esters as herbicidal agents and carriers for herbicidal agents. Compositions of such type can be applied to areas containing both desired and undesired plants, to kill the undesired plants without harming the desired plants.

### FIELD OF THE INVENTION

The present invention relates to herbicidal compositions comprising fatty acids and fatty acid esters as herbicidal agents, herbicidal carriers including esters of fatty acids, and methods for killing unwanted plants using the same.

### DESCRIPTION OF THE RELATED ART

For thousands of years man has used various methods to kill unwanted plants. Methods have ranged from pulling unwanted plants from the ground to physically destroying unwanted plants with stone and metal farm or garden tools to using various herbicides to poison and kill unwanted plants.

An important motivation for killing unwanted plants is to ensure that desired plants in the same location are able to obtain requisite or optimal amounts of water, light, and food and minerals, often from a limited supply of such necessities, with little or no competition from the unwanted plants. Another common motivating factor is the desire to eliminate plants, like poison ivy, which have side effects detrimental to humans.

Relatively recent developments in plant and weed control technologies have made unwanted plant eradication much easier than during earlier times. An example of a recent technological advance is glyophosate (glyophosate herein refers to N-(phosphonomethyl)glycine, in the form of its isopropylamine salt(s)), which is listed as an ingredient of Monsanto's Roundup® herbicide. Upon exposing glyphosate to a plant in sufficient quantities, the plant's naturally-occurring growth enzyme, EPSP synthase, fails to function, thereby killing the plant in a period of days or weeks.

While the herbicide Roundup® is highly effective in killing naturally occurring plants which use the EPSP synthase to regulate plant growth, it is ineffective for genetically modified plants having non-EPSP plant growth enzymes, which as a result are not susceptible to the harmful effects of glyophosate. Many plant varieties have the requisite alternative DNA sequences, including corn, soybeans, rapeseed, cotton, etc.

One advantage to using Roundup® is avoiding the cost and time otherwise required to kill invasive weed species that would otherwise threaten a crop. Another advantage to using Roundup® is having the ability to uniformly spray an area of both unwanted and desired plants without damaging the desired plants, while selectively eliminating the unwanted plants.

Despite glyophsate's enormous benefits, not all plant cultivators wish to use genetically modified seeds that are required when glyophosate is applied to an area including desired as well as unwanted plants. Additionally, some plant cultivators fear that plants may eventually build up a resistance to this and other more recently developed herbicides. As a result of these and other concerns, alternative and often “greener” methods of killing unwanted plants are favored by some plant cultivators. These methodologies include the application of various spices, vinegar, steam and flame.

While some these “greener” methods are older and deemed more environmentally friendly, they have generally not been viable for large-scale commercial use, for various reasons, including cost, and the necessity of selective application to unwanted plants, while avoiding application of the cidal agent to the desired plants.

While glyophosate and other modern herbicides, as well as “green” herbicides, are often extremely effective in killing unwanted plants, their various associated deficiencies remain. As a result, there is a continuing need for safe and effective plant herbicides that are ecologically acceptable, and simple and economic to use.

### SUMMARY OF THE INVENTION

The present invention relates to herbicidal compositions and methods of using same for killing unwanted plants. In specific aspects, the invention relates to the use of fatty acids and esters of fatty acids in herbicidal compositions as herbicidal agents, and to enhancement of the efficacy of herbicidal agents by using mono alkyl esters of long chain fatty acids carriers.

As used herein, the term “fatty acids” refers to alkyl chains having a carboxylic acid substituent at one end of the alkyl chain and a methyl (CH₃) substituent at the other end of the alkyl chain. Such fatty acids may be saturated or unsaturated. The term “long chain fatty acids” as used herein refers to alkyl chains having 14 to 24 carbon atoms. Fatty acids of fewer than fourteen carbon atoms are referred to herein by their carboxylic acid name, such as hexanoic acid, heptanoic acid, octanoic acid, nonanoic acid, decanoic acid, undecanoic acid, dodecanoic acid, etc.

In one aspect, the invention relates to a composition including (i) an herbicidal agent and (ii) a carrier comprising mono alkyl esters of long chain fatty acids.

Another aspect of the present invention relates to a method of killing unwanted plants by application to such plants of an herbicidal composition comprising an herbicidal agent and a carrier including mono alkyl esters of long chain fatty acids.

Another aspect of the present invention relates to a method of killing unwanted plants by application to such plants of an herbicidal composition including one or more carboxylic acids selected from the group consisting of hexanoic acid, heptanoic acid, octanoic acid, nonanoic acid, decanoic acid, undecanoic acid, and dodecanoic acid. In one preferred aspect, the herbicidal composition comprises one or more carboxylic acids selected from the group consisting of hexanoic acid, octanoic acid, decanoic acid, and dodecanoic acid. In other preferred aspects, herbicidal compositions can include methyl, ethyl and/or propyl esters of the aforementioned carboxylic acids.

Another aspect of the invention relates to a method of controlling the growth of unwanted plants in a locus containing unwanted and desired plants. Such method involves applying to the locus a composition comprising (i) an herbicidal agent and (ii) a carrier comprising mono alkyl esters of long chain fatty acids, in which the composition contains an amount of herbicidal agent that is sufficient to kill the unwanted plants but insufficient to kill the desired plants.

Other aspects, features and embodiments of the invention will be more fully apparent from the ensuing disclosure and appended claims.

### DETAILED DESCRIPTION OF THE INVENTION AND PREFERRED EMBODIMENTS THEREOF

The present invention relates to herbicidal compositions and methods of using same for killing unwanted plants, involving, in various specific aspects, the use of fatty acids and esters of fatty acids as herbicidal agents, and the use of mono alkyl esters of long chain fatty acids as carriers to enhance the efficacy of herbicidal agents.

In various embodiments, the invention contemplates compositions including (i) an herbicidal agent and (ii) a carrier comprising mono alkyl esters of long chain fatty acids.

The carrier can, for example, comprise one or more mono alkyl esters selected from the group consisting of C₁₄-C₂₄ saturated methyl esters, C₁₄-C₂₄ unsaturated methyl esters, C₁₄-C₂₄ saturated ethyl esters, C₁₄-C₂₄ unsaturated ethyl esters, and C₁₄-C₂₄ saturated propyl esters and C₁₄-C₂₄ unsaturated propyl esters. In various formulations, the carrier includes one or more mono alkyl esters selected from the group consisting of C₁₆-C₁₈ saturated methyl esters, C₁₈ unsaturated methyl esters, C₁₆-C₁₈ saturated ethyl esters, C₁₈ unsaturated ethyl esters, C₁₆-C₁₈ saturated propyl esters and C₁₈ unsaturated propyl esters.

As used herein, the designation of organo substituents by reference to carbon numbers, includes ranges as well as sub-ranges within the ranges identified by end-point carbon numbers, and such sub-ranges may be specified, e.g., as including one of such end-point carbon numbers in such a sub-range, or as including carbon numbers greater than the lower end-point carbon number and less than the upper end-point carbon number of the range, to constitute various sub-ranges in the various specific embodiments of the invention. Alkyl groups may be branched or unbranched.

The long chain fatty acids in specific embodiments may comprise fatty acids selected from among vegetable oil long chain fatty acids, animal source long chain fatty acids, and mixtures thereof. In specific compositions, the carrier may, for example, comprise one or more mono alkyl esters selected from the group consisting of soybean oil methyl ester, soybean oil ethyl ester, soybean oil propyl ester, coconut oil methyl ester, coconut oil ethyl ester, coconut oil propyl ester, palm oil methyl ester, palm oil ethyl ester, palm oil propyl ester, cotton seed oil methyl ester, cotton seed oil ethyl ester, cotton seed oil propyl ester, wheat germ methyl ester, wheat germ ethyl ester, wheat germ propyl ester, olive oil methyl ester, olive oil ethyl ester, olive oil propyl ester, corn oil methyl ester, corn oil ethyl ester, corn oil propyl ester, sunflower oil methyl ester, sunflower oil ethyl ester, sunflower oil propyl ester, safflower oil methyl ester, safflower oil ethyl ester, safflower oil propyl ester, rapeseed oil methyl ester, rapeseed oil ethyl ester, rapeseed oil propyl ester, mustard oil methyl ester, mustard oil ethyl ester, mustard oil propyl ester, jatropha methyl ester, jatropha ethyl ester, jatropha propyl ester, algae methyl ester, algae ethyl ester, algae propyl ester, tallow methyl ester, tallow ethyl ester, tallow propyl ester, methyl palmitate, ethyl palmitate, propyl palmitate, methyl stearate, ethyl stearate, propyl stearate, methyl oleate, ethyl oleate, propyl oleate, methyl linoleate, ethyl linoleate, and propyl linoleate. In specific compositions, the carrier comprises material identified by Chemical Abstracts Registry Number (CAS#) 67784-80-9 or material identified by Chemical Abstracts Registry Number (CAS#) 6772-38-3. As used herein, the term “soybean oil esters” is synonymous with soybean esters and also is synonymous with soy esters.

The compositions of the invention may be provided in any suitable form, e.g., a solution or an emulsion. The compositions may further include one or more ingredients selected from the group consisting of fillers, dispersants, water, non-aqueous solvent media, surfactants, suspension agents, sticking agents, stabilizers, preservatives, dyes, pigments, masking agents, emollients, excipients, and post-application detection agents. In various specific embodiments, the composition comprises at least one additional ingredient selected from the group consisting of lauric acid, olefin sulfanate, pegulated castor oil, cyclomethicone, cedarwood oil, citric acid, water, lemongrass oil, and benzoic acid.

The herbicidal agent used in compositions of the present invention can be of any suitable type and may, for example, include one or more compounds selected from the group consisting of hexanoic acid, heptanoic acid, octanoic acid, nonanoic acid, decanoic acid, undecanoic acid, dodecanoic acid, methyl hexanoate, methyl heptanoate, methyl octanoate, methyl nonanoate, methyl decanoate, methyl undecanoate, and methyl dodecanoate, ethyl hexanoate, ethyl heptanoate, ethyl octanoate, ethyl nonanoate, ethyl decanoate, ethyl undecanoate, and ethyl dodecanoate, propyl hexanoate, propyl heptanoate, propyl octanoate, propyl nonanoate, propyl decanoate, propyl undecanoate, and propyl dodecanoate. In various preferred embodiments, the herbicidal agent can be or include hexanoic acid, octanoic acid, decanoic acid, dodecanoic acid, methyl hexanoate, methyl octanoate, methyl decanoate, and/or methyl dodecanoate.

In various embodiments of the present invention, the herbicidal agent comprises one or more herbicides selected from the group consisting of acetyl co-enzyme A corboxylase enzyme inhibitors, acetolactate synthase enzyme inhibitors, enolpyruvylshikimate 3-phosphate synthase enzyme inhibitors, synthetic auxin, and photosystem II inhibitors, amitrole, asulam, atrazine, bromacil, bromacil and diuron, bipyridilium, chlorsulfuro, clopyralid, clopyralid and 2,4-D, 2,4-D, dalapon, dicamba, dicamba and 2,4-D, diuron, fosamine, glufosinate, glyophosate, glyphosate and 2,4-D, glyphosate and dicamba, hexazinone, imazapyr, imazapyr and diuron, imazapic, mefluidide, metsulfuron, picloram, picloram and 2,4-D, simazine, sulfometuron, tebuthiuron, tebuthiuron and diuron, triclopyr, triclopyr and 2,4-D, triclopyr and clopyralid. In one preferred embodiment of the present invention, the herbicidal agent comprises glyophosate.

The compositions of the invention can be formulated with any suitable concentrations of ingredients, e.g., from 0.05 to 99.95% by weight of the herbicidal agent, and from 0.05% to 99.95% by weight of the carrier. In various embodiments, the composition comprises from 1 to 90% by weight of the herbicidal agent and from 1 to 90% by weight of the carrier. In other embodiments of the invention, the composition further comprises 1 to 90% by weight emulsifying agents. In the above formulations the weight percentages of all ingredients total to one hundred weight percent.

In one embodiment of the present invention, the composition comprises from 10 to 40% by weight of one or more acids selected from the group consisting of hexanoic acid, octanoic acid, decanoic acid, and dodecanoic acid, from 10 to 40% by weight of soybean oil methyl ester, from 10 to 60% by weight of water, from 10 to 40% by weight of cyclomethicone, from 0.05 to 5% by weight of lauric acid, from 0.05 to 5% by weight of olefin sulfanate, from 0.05 to 5% by weight of pegylated castor oil, from 0.05 to 5% by weight of cedar oil, from 0.05 to 5% by weight of citric acid, from 0.05 to 5% by weight of lemon grass oil, and from 0.05 to 5% by weight of benzoic acid, wherein the weight percents of all ingredients total to one hundred weight percent.

In another aspect of the present invention, the herbicidal agent comprises one or more carboxylic acids selected from the group consisting of hexanoic acid, octanoic acid, decanoic acid, and dodecanoic acid, and the carrier comprises one or more alkyl esters selected from the group consisting of hexadecanoic methyl ester, octadecanoic methyl ester, 9-octadecenoic methyl ester (Z), 9,12-octadecandienoic methyl ester (Z,Z), and 9,12,15 octadecatrienoic methyl ester (9Z,12Z,15Z).

In yet another aspect of the instant invention, the herbicidal agent comprises one or more methyl esters selected from the group consisting of methyl hexanoate, methyl octanoate, methyl decanoate, and methyl dodecanoate, and the carrier comprises one or more alkyl esters selected from the group consisting of hexadecanoic methyl ester, octadecanoic methyl ester, 9-octadecenoic methyl ester (Z), 9,12-octadecandienoic methyl ester (Z,Z), and 9,12,15 octadecatrienoic methyl ester (9Z,12Z,15Z).

In other embodiments of the present invention, the herbicidal agent comprises one or more carboxylic acids selected from the group consisting of hexanoic acid, octanoic acid, decanoic acid, and dodecanoic acid. In another embodiment, the herbicidal agent includes material identified by Chemical Abstracts Registry Number (CAS#) 67762-36-1. In these and other embodiments, the carrier may for example comprise material identified by Chemical Abstracts Registry Number (CAS#) 67784-80-9, or material identified by Chemical Abstracts Registry Number (CAS#) 67762-38-3, or one or more alkyl esters selected from the group consisting of hexadecanoic methyl ester, octadecanoic methyl ester, 9-octadecenoic methyl ester (Z), 9,12-octadecandienoic methyl ester (Z,Z), and 9,12,15 octadecatrienoic methyl ester (9Z,12Z,15Z).

In still further embodiments of the present invention, the herbicidal agent can comprise one or more methyl esters selected from the group consisting of methyl hexanoate, methyl octanoate, methyl decanoate, and methyl dodecanoate. In other embodiments, the herbicidal agent can comprise methyl esters of the material identified by Chemical Abstracts Registry Number (CAS#) 67762-36-1. In these and other embodiments, the carrier can comprise material identified by Chemical Abstracts Registry Number (CAS#) 67784-80-9, or material identified by Chemical Abstracts Registry Number (CAS#) 67762-38-3, or one or more alkyl esters selected from the group consisting of hexadecanoic methyl ester, octadecanoic methyl ester, 9-octadecenoic methyl ester (Z), 9,12-octadecandienoic methyl ester (Z,Z), and 9,12,15 octadecatrienoic methyl ester (9Z,12Z,15Z).

In still other embodiments of the present invention, the herbicidal agent comprises octanoic acid and decanoic acid, or methyl ocatnoate and methyl decanoate, and the carrier comprises material identified by Chemical Abstracts Registry Number (CAS#) 67762-38-3 or material identified by Chemical Abstracts Registry Number (CAS#) 67784-80-9.

In additional embodiments of the present invention, the herbicidal agent may include one or more carboxylic acids selected from the group consisting of hexanoic acid, heptanoic acid, octanoic acid, nonanoic acid, decanoic acid, undecanoic acid, and dodecanoic acid, or one or more methyl esters selected from the group consisting of methyl hexanoate, methyl heptanoate, methyl octanoate, methyl nonanoate, methyl decanoate, methyl undecanoate, and methyl dodecanoate. The carrier in such compositions may comprise one or more alkyl esters selected from the group consisting of hexadecanoic methyl ester, octadecanoic methyl ester, 9-octadecenoic methyl ester (Z), 9,12-octadecandienoic methyl ester (Z,Z), and 9,12,15 octadecatrienoic methyl ester (9Z,12Z,15Z).

In other specific embodiments of the present invention, the herbicidal agent comprises material identified by Chemical Abstracts Registry Number (CAS#) 67762-36-1, or methyl esters of the material identified by Chemical Abstracts Registry Number (CAS#) 67762-36-1, and the carrier comprises material identified by Chemical Abstracts Registry Number (CAS#) 67784-80-9 or material identified by Chemical Abstracts Registry Number (CAS#) 67762-38-3.

In one specific aspect of the invention, the composition includes from 10 to 40% by weight of octanoic and decanoic acid, or methyl octanoate and methyl decanoate, from 10 to 40% by weight of soybean methyl ester, from 10 to 60% by weight of water, from 10 to 40% by weight of cyclomethicone, from 0.05 to 5% by weight of lauric acid, from 0.05 to 5% by weight of olefin sulfanate, from 0.05 to 5% by weight of pegylated castor oil, from 0.05 to 5% by weight of cedar oil, from 0.05 to 5% by weight of citric acid, from 0.05 to 5% by weight of lemon grass oil, and from 0.05 to 5% by weight of benzoic acid, wherein the weight percents of all ingredients total to one hundred weight percent.

In another aspect of the current invention, the composition comprises 10 to 40% by weight of material identified by Chemical Abstracts Registry Number (CAS#) 67762-36-1 or the methyl esters of material identified by Chemical Abstracts Registry Number (CAS#) 67762-36-1, from 10 to 40% by weight of material identified by Chemical Abstracts Registry Number (CAS#) 67784-80-9, from 10 to 60% by weight of water, from 10 to 40% by weight of cyclomethicone, from 0.05 to 5% by weight of lauric acid, from 0.05 to 5% by weight of olefin sulfanate, from 0.05 to 5% by weight of pegylated castor oil, from 0.05 to 5% by weight of cedar oil, from 0.05 to 5% by weight of citric acid, from 0.05 to 5% by weight of lemon grass oil, and from 0.05 to 5% by weight of benzoic acid, wherein the weight percents of all ingredients total to one hundred weight percent.

In yet another aspect of the current invention, the composition comprises 10 to 40% by weight of material identified by Chemical Abstracts Registry Number (CAS#) 67762-36-1 or the methyl esters of material identified by Chemical Abstracts Registry Number (CAS#) 67762-36-1, from 10 to 40% by weight of material identified by Chemical Abstracts Registry Number (CAS#) 67762-38-3, from 10 to 60% by weight of water, from 10 to 40% by weight of cyclomethicone, from 0.05 to 5% by weight of lauric acid, from 0.05 to 5% by weight of olefin sulfanate, from 0.05 to 5% by weight of pegylated castor oil, from 0.05 to 5% by weight of cedar oil, from 0.05 to 5% by weight of citric acid, from 0.05 to 5% by weight of lemon grass oil, and from 0.05 to 5% by weight of benzoic acid, wherein the weight percents of all ingredients total to one hundred weight percent.

In one aspect, the present invention relates to a method of killing unwanted plants by applying to such plants an herbicidal composition containing one or more carboxylic acids selected from the group consisting of hexanoic acid, heptanoic acid, octanoic acid, nonanoic acid, decanoic acid, undecanoic acid, and dodecanoic acid. In a specific embodiment, the herbicidal composition comprises one or more carboxylic acids selected from the group consisting of hexanoic acid, octanoic acid, decanoic acid, and dodecanoic acid. In another embodiment, the herbicidal composition comprises the material identified by Chemical Abstracts Registry Number (CAS#) 67762-36-1.

In another embodiment, the present invention relates to a method of killing unwanted plants by applying to such plants an herbicidal composition comprising one or more methyl esters selected from the group consisting of methyl hexanoate, methyl heptanoate, methyl octanoate, methyl nonanoate, methyl decanoate, methyl undecanoate, and methyl dodecanoate. In yet another embodiment, the herbicidal composition comprises one or more methyl esters selected from the group consisting of methyl hexanoate, methyl octanoate, methyl decanoate, and methyl dodecanoate. In a still further embodiment, the herbicidal composition comprises methyl esters of the material identified by Chemical Abstracts Registry Number (CAS#) 67762-36-1. In other embodiments of the present invention, ethyl and propyl esters may be used in place of the methyl esters.

Another embodiment relates to a method of killing unwanted plants by applying to such plants an herbicidal composition containing one or more compounds of the material identified by Chemical Abstracts Registry Number (CAS#) 67762-36-1.

In certain embodiments, herbicidal competitions of the invention may be formulated to be free of (i) ethyl esters of fatty acids, e.g., ethyl esters having a level of unsaturation of at least 40% by weight; and (ii) non-ionic emulsifiers.

In one aspect, the present invention relates to a method of controlling the growth of unwanted plants in a locus containing unwanted and desired plants, by applying to the locus a composition comprising (i) an herbicidal agent and (ii) a carrier comprising mono alkyl esters of long chain fatty acids, in which the composition comprises an amount of the herbicidal agent that is sufficient to kill the unwanted plants but insufficient to kill the desired plants.

The features and advantages of the invention are more fully shown by the following non-limiting examples.

### EXAMPLE 1

An herbicidal composition including material identified by Chemical Abstracts Registry Number (CAS#) 67762-36-1 and a carrier comprising material identified by Chemical Abstracts Registry Number (CAS#) 67762-38-3, was sprayed on a mulch area with a high infestation of weeds, grass and other unwanted vegetation. Within 1 day the vegetation in the sprayed area turned black and within 1 week all vegetation was dead and decaying. This area remained completely dead four months after spraying.

### EXAMPLE 2

The composition of Example 1 was sprayed on a 10 foot long×3 foot wide×5 foot high area of established (during three years) poison ivy growing in and around a garden fence, with application of 16 oz. of such composition. Within 1 day the poison ivy leaves turned black and within 1 week 90% of the poison ivy was dead. A couple branches, on which leaves were starting to develop, survived into the next month. A second application of 8 oz. of the composition of Example 1 was applied to the new growth and to new ground saplings in a portion of the area. Within 1 month all poison ivy was dead and no new growth was evident. At that time, all branches had turned black and were decaying.

### EXAMPLE 3

A 10 foot by 3 foot non-mulched area containing new growth poison ivy along with high grass and weeds was sprayed with a composition containing only material identified by Chemical Abstracts Registry Number (CAS#) 67762-38-3. After 1 day, there was a slight yellowing of the vegetation. After 1 week there was no remaining effects of the spraying of such composition, and the color of the vegetation had recovered.

### EXAMPLE 4

The material identified by Chemical Abstracts Registry Number (CAS#) 67762-38-3 was sprayed on a mulch area where weeds, grass and unwanted vegetation were present. The vegetation turned slightly yellow but recovered its normal color within 1 week.

### EXAMPLE 5

The same non-mulched area sprayed in Example 3 was sprayed four months later with a composition comprising a herbicidal agent material (Chemical Abstracts Registry Number (CAS#) 67762-36-1) and a carrier material (Chemical Abstracts Registry Number (CAS#) 67762-38-3). Within 1 week all poison ivy, high grass and weeds was dead in the treated area.

While the invention has been described herein in reference to specific aspects, features and illustrative embodiments of the invention, it will be appreciated that the utility of the invention is not thus limited, but rather extends to and encompasses numerous other variations, modifications and alternative embodiments, as will suggest themselves to those of ordinary skill in the field of the present invention, based on the disclosure herein. Correspondingly, the invention as hereinafter claimed is intended to be broadly construed and interpreted, as including all such variations, modifications and alternative embodiments, within its spirit and scope.

What is claimed is:

1. A composition comprising (i) an herbicidal agent and (ii) a carrier comprising mono alkyl esters of long chain fatty acids.

2. The composition of claim 1, wherein the carrier comprises one or more mono alkyl esters selected from the group consisting of C₁₄-C₂₄ saturated methyl esters, C₁₄-C₂₄ unsaturated methyl esters, C₁₄-C₂₄ saturated ethyl esters, C₁₄-C₂₄ unsaturated ethyl esters, C₁₄-C₂₄ saturated propyl esters, C₁₄-C₂₄ unsaturated propyl esters, C₁₆-C₁₈ saturated methyl esters, C₁₈ unsaturated methyl esters, C₁₆-C₁₈ saturated ethyl esters, C₁₈ unsaturated ethyl esters, C₁₆-C₁₈ saturated propyl esters and C₁₈ unsaturated propyl esters.

3. The composition of claim 1, wherein the long chain fatty acids comprise fatty acids selected from among vegetable oil long chain fatty acids, animal source long chain fatty acids, and mixtures thereof.

4. The composition of claim 1, wherein the carrier comprises one or more mono alkyl esters selected from the group consisting of soybean oil methyl ester, soybean oil ethyl ester, soybean oil propyl ester, coconut oil methyl ester, coconut oil ethyl ester, coconut oil propyl ester, palm oil methyl ester, palm oil ethyl ester, palm oil propyl ester, cotton seed oil methyl ester, cotton seed oil ethyl ester, cotton seed oil propyl ester, wheat germ methyl ester, wheat germ ethyl ester, wheat germ propyl ester, olive oil methyl ester, olive oil ethyl ester, olive oil propyl ester, corn oil methyl ester, corn oil ethyl ester, corn oil propyl ester, sunflower oil methyl ester, sunflower oil ethyl ester, sunflower oil propyl ester, safflower oil methyl ester, safflower oil ethyl ester, safflower oil propyl ester, rapeseed oil methyl ester, rapeseed oil ethyl ester, rapeseed oil propyl ester, mustard oil methyl ester, mustard oil ethyl ester, mustard oil propyl ester, jatropha methyl ester, jatropha ethyl ester, jatropha propyl ester, algae methyl ester, algae ethyl ester, algae propyl ester, tallow methyl ester, tallow ethyl ester, tallow propyl ester, methyl palmitate, ethyl palmitate, propyl palmitate, methyl stearate, ethyl stearate, propyl stearate, methyl oleate, ethyl oleate, propyl oleate, methyl linoleate, ethyl linoleate, and propyl linoleate.

5. The composition of claim 1, wherein the carrier comprises material selected from among material identified by Chemical Abstracts Registry Number (CAS#) 67784-80-9, material identified by Chemical Abstracts Registry Number (CAS#) 6772-38-3, and mixtures thereof.

6. The composition of claim 1, wherein the composition comprises a solution or an emulsion.

7. The composition of claim 1, further comprising one or more ingredients selected from the group consisting of fillers, dispersants, water, non-aqueous solvent media, surfactants, suspension agents, sticking agents, stabilizers, preservatives, dyes, pigments, masking agents, emollients, excipients, post-application detection agents, lauric acid, olefin sulfanate, pegylated castor oil, cyclomethicone, cedarwood oil, citric acid, water, lemongrass oil, and benzoic acid.

8. The composition of claim 1, wherein the herbicidal agent comprises one or more compounds selected from the group consisting of hexanoic acid, heptanoic acid, octanoic acid, nonanoic acid, decanoic acid, undecanoic acid, dodecanoic acid, methyl hexanoate, methyl heptanoate, methyl octanoate, methyl nonanoate, methyl decanoate, methyl undecanoate, and methyl dodecanoate, ethyl hexanoate, ethyl heptanoate, ethyl octanoate, ethyl nonanoate, ethyl decanoate, ethyl undecanoate, and ethyl dodecanoate, propyl hexanoate, propyl heptanoate, propyl octanoate, propyl nonanoate, propyl decanoate, propyl undecanoate, and propyl dodecanoate.

9. The composition of claim 1, wherein the herbicidal agent comprises at least one component selected from among (i), (ii) and (iii):
(i) acids selected from the group consisting of hexanoic acid, octanoic acid, decanoic acid, and dodecanoic acid;
(ii) methyl esters selected from the group consisting of methyl hexanoate, methyl octanoate, methyl decanoate, and methyl dodecanoate; and
(iii) mixtures of (i) and (ii).

10. The composition of claim 1, wherein the herbicidal agent comprises one or more herbicides selected from the group consisting of acetyl co-enzyme A carboxylase enzyme inhibitors, acetolactate synthase enzyme inhibitors, enolpyruvylshikimate 3-phosphate synthase enzyme inhibitors, synthetic auxin, and photosystem II inhibitors, amitrole, asulam, atrazine, bromacil, bromacil and diuron, bipyridilium, chlorsulfuro, clopyralid, clopyralid and 2,4-D, 2,4-D, dalapon, dicamba, dicamba and 2,4-D, diuron, fosamine, glyophosate, glyphosate and 2,4-D, glufosinate, glyphosate and dicamba, hexazinone, imazapyr, imazapyr and diuron, imazapic, mefluidide, metsulfuron, picloram, picloram and 2,4-D, simazine, sulfometuron, tebuthiuron, tebuthiuron and diuron, triclopyr, triclopyr and 2,4-D, triclopyr and clopyralid.

11. The composition of claim 1, wherein the composition comprises from 0.05 to 99.95% by weight of the herbicidal agent and from 0.05% to 99.95% by weight of the carrier, wherein weight percents of all ingredients total to 100 weight percent.

12. The composition of claim 1, wherein the composition further comprises from 1 to 90% by weight of emulsifying agents, wherein weight percents of all ingredients total to 100 weight percent.

13. The composition of claim 1, wherein the herbicidal agent is selected from the group consisting of (i), (ii), (iii), (iv), (v), (vi), (vii), (viii), (ix), and (x):
(i) one or more acids selected from the group consisting of hexanoic acid, octanoic acid, decanoic acid, and dodecanoic acid;
(ii) one or more methyl esters selected from the group consisting of methyl hexanoate, methyl octanoate, methyl decanoate, and methyl dodecanoate;
(iii) material identified by Chemical Abstracts Registry Number (CAS#) 67762-36-1;
(iv) methyl esters of material identified by Chemical Abstracts Registry Number (CAS#) 67762-36-1;
(v) one or more acids selected from the group of acids consisting of octanoic acid and decanoic acid;
(vi) one or more methyl esters selected from the group consisting of methyl octanoate and methyl decanoate;
(vii) one or more carboxylic acids selected from the group consisting of hexanoic acid, heptanoic acid, octanoic acid, nonanoic acid, decanoic acid, undecanoic acid, and dodecanoic acid;
(viii) one or more methyl esters selected from the group consisting of methyl hexanoate, methyl heptanoate, methyl octanoate, methyl nonanoate, methyl decanoate, methyl undecanoate, and methyl dodecanoate;
(ix) one or more ethyl esters selected from the group consisting of ethyl hexanoate, ethyl octanoate, ethyl decanoate, and ethyl dodecanoate;
(x) one or more propyl esters selected from the group consisting of propyl hexanoate, propyl octanoate, propyl decanoate, and propyl dodecanoate;
and the carrier is selected from the group consisting of (a), (b), (c), and (d):
(a) soybean oil methyl ester;
(b) material identified by Chemical Abstracts Registry Number (CAS#) 67784-80-9;
(c) material identified by Chemical Abstracts Registry Number (CAS#) 67762-38-3; and
(d) one or more alkyl esters selected from the group consisting of hexadecanoic methyl ester, octadecanoic methyl ester, 9-octadecenoic methyl ester (Z), 9,12-octadecandienoic methyl ester (Z,Z), and 9,12,15 octadecatrienoic methyl ester (9Z,12Z,15Z).

14. The composition of claim 1, wherein the composition comprises from 10 to 40% by weight the herbicidal agent selected from the group consisting of (i), (ii), (iii), (iv), (v), (vi), (vii), (viii), (ix), and (x):
(i) one or more acids selected from the group consisting of hexanoic acid, octanoic acid, decanoic acid, and dodecanoic acid;
(ii) one or more methyl esters selected from the group consisting of methyl hexanoate, methyl octanoate, methyl decanoate, and methyl dodecanoate;
(iii) material identified by Chemical Abstracts Registry Number (CAS#) 67762-36-1;
(iv) comprises methyl esters of material identified by Chemical Abstracts Registry Number (CAS#) 67762-36-1;
(v) one or more acids selected from the group of acids consisting of octanoic acid and decanoic acid;
(vi) one or more methyl esters selected from the group consisting of methyl octanoate and methyl decanoate;
(vii) one or more carboxylic acids selected from the group consisting of hexanoic acid, heptanoic acid, octanoic acid, nonanoic acid, decanoic acid, undecanoic acid, and dodecanoic acid;
(viii) one or more methyl esters selected from the group consisting of methyl hexanoate, methyl heptanoate, methyl octanoate, methyl nonanoate, methyl decanoate, methyl undecanoate, and methyl dodecanoate;
(ix) one or more ethyl esters selected from the group consisting of ethyl hexanoate, ethyl octanoate, ethyl decanoate, and ethyl dodecanoate;
(x) one or more propyl esters selected from the group consisting of propyl hexanoate, propyl octanoate, propyl decanoate, and propyl dodecanoate;
from 10 to 40% by weight of the carrier selected from the group consisting of (a), (b), (c), and (d):
(a) soybean oil methyl ester;
(b) material identified by Chemical Abstracts Registry Number (CAS#) 67784-80-9;
(c) material identified by Chemical Abstracts Registry Number (CAS#) 67762-38-3; and
(d) one or more alkyl esters selected from the group consisting of hexadecanoic methyl ester, octadecanoic methyl ester, 9-octadecenoic methyl ester (Z), 9,12-octadecandienoic methyl ester (Z,Z), and 9,12,15 octadecatrienoic methyl ester (9Z,12Z,15Z); and
from 10 to 60% by weight of water; from 10 to 40% by weight of cyclomethicone; from 0.05 to 5% by weight of lauric acid; from 0.05 to 5% by weight of olefin sulfanate; from 0.05 to 5% by weight of pegylated castor oil; from 0.05 to 5% by weight of cedar oil; from 0.05 to 5% by weight of citric acid; from 0.05 to 5% by weight of lemon grass oil; and from 0.05 to 5% by weight of benzoic acid, and wherein weight percents of all ingredients total to 100 weight percent.

15. A method of killing unwanted plants, comprising applying to said plants an herbicidal composition comprising (i) an herbicidal agent and (ii) a carrier comprising mono alkyl esters of long chain fatty acids.

16. The method of claim 15, wherein the carrier comprises one or more mono alkyl esters selected from the group consisting of C₁₄-C₂₄ saturated methyl esters, C₁₄-C₂₄ unsaturated methyl esters, C₁₄-C₂₄ saturated ethyl esters, C₁₄-C₂₄ unsaturated ethyl esters, C₁₄-C₂₄ saturated propyl esters, C₁₄-C₂₄ unsaturated propyl esters, C₁₆-C₁₈ saturated methyl esters, C₁₈ unsaturated methyl esters, C₁₆-C₁₈ saturated ethyl esters, C₁₈ unsaturated ethyl esters, C₁₆-C₁₈ saturated propyl esters and C₁₈ unsaturated propyl esters.

17. The method of claim 15, wherein the carrier comprises one or more mono alkyl esters selected from the group consisting of soybean oil methyl ester, soybean oil ethyl ester, soybean oil propyl ester, coconut oil methyl ester, coconut oil ethyl ester, coconut oil propyl ester, palm oil methyl ester, palm oil ethyl ester, palm oil propyl ester, cotton seed oil methyl ester, cotton seed oil ethyl ester, cotton seed oil propyl ester, wheat germ methyl ester, wheat germ ethyl ester, wheat germ propyl ester, olive oil methyl ester, olive oil ethyl ester, olive oil propyl ester, corn oil methyl ester, corn oil ethyl ester, corn oil propyl ester, sunflower oil methyl ester, sunflower oil ethyl ester, sunflower oil propyl ester, safflower oil methyl ester, safflower oil ethyl ester, safflower oil propyl ester, rapeseed oil methyl ester, rapeseed oil ethyl ester, rapeseed oil propyl ester, mustard oil methyl ester, mustard oil ethyl ester, mustard oil propyl ester, jatropha methyl ester, jatropha ethyl ester, jatropha propyl ester, algae methyl ester, algae ethyl ester, algae propyl ester, tallow methyl ester, tallow ethyl ester, tallow propyl ester, methyl palmitate, ethyl palmitate, propyl palmitate, methyl stearate, ethyl stearate, propyl stearate, methyl oleate, ethyl oleate, propyl oleate, methyl linoleate, ethyl linoleate, and propyl linoleate.

18. The method of claim 15, wherein the herbicidal agent comprises one or more compounds selected from the group consisting of hexanoic acid, heptanoic acid, octanoic acid, nonanoic acid, decanoic acid, undecanoic acid, dodecanoic acid, methyl hexanoate, methyl heptanoate, methyl octanoate, methyl nonanoate, methyl decanoate, methyl undecanoate, and methyl dodecanoate, ethyl hexanoate, ethyl heptanoate, ethyl octanoate, ethyl nonanoate, ethyl decanoate, ethyl undecanoate, and ethyl dodecanoate, propyl hexanoate, propyl heptanoate, propyl octanoate, propyl nonanoate, propyl decanoate, propyl undecanoate, and propyl dodecanoate

19. The method of claim 15, wherein the herbicidal agent comprises one or more herbicides selected from the group consisting of acetyl co-enzyme A carboxylase enzyme inhibitors, acetolactate synthase enzyme inhibitors, enolpyruvylshikimate 3-phosphate synthase enzyme inhibitors, synthetic auxin, and photosystem II inhibitors, amitrole, asulam, atrazine, bromacil, bromacil and diuron, bipyridilium, chlorsulfuro, clopyralid, clopyralid and 2,4-D, 2,4-D, dalapon, dicamba, dicamba and 2,4-D, diuron, fosamine, glyophosate, glyphosate and 2,4-D, glufosinate, glyphosate and dicamba, hexazinone, imazapyr, imazapyr and diuron, imazapic, mefluidide, metsulfuron, picloram, picloram and 2,4-D, simazine, sulfometuron, tebuthiuron, tebuthiuron and diuron, triclopyr, triclopyr and 2,4-D, triclopyr and clopyralid.

20. The method of claim 15, wherein the herbicidal agent is selected from the group consisting of (i), (ii), (iii), (iv), (v), (vi), (vii), (viii), (ix), and (x):
(i) one or more acids selected from the group consisting of hexanoic acid, octanoic acid, decanoic acid, and dodecanoic acid;
(ii) one or more methyl esters selected from the group consisting of methyl hexanoate, methyl octanoate, methyl decanoate, and methyl dodecanoate;
(iii) material identified by Chemical Abstracts Registry Number (CAS#) 67762-36-1;
(iv) methyl esters of material identified by Chemical Abstracts Registry Number (CAS#) 67762-36-1;
(v) one or more acids selected from the group of acids consisting of octanoic acid and decanoic acid;
(vi) one or more methyl esters selected from the group consisting of methyl octanoate and methyl decanoate;
(vii) one or more carboxylic acids selected from the group consisting of hexanoic acid, heptanoic acid, octanoic acid, nonanoic acid, decanoic acid, undecanoic acid, and dodecanoic acid;
(viii) one or more methyl esters selected from the group consisting of methyl hexanoate, methyl heptanoate, methyl octanoate, methyl nonanoate, methyl decanoate, methyl undecanoate, and methyl dodecanoate;
(ix) one or more ethyl esters selected from the group consisting of ethyl hexanoate, ethyl octanoate, ethyl decanoate, and ethyl dodecanoate;
(x) one or more propyl esters selected from the group consisting of propyl hexanoate, propyl octanoate, propyl decanoate, and propyl dodecanoate;
and the carrier is selected from the group consisting of (a), (b), (c), and (d):
(a) soybean oil methyl ester;
(b) material identified by Chemical Abstracts Registry Number (CAS#) 67784-80-9;
(c) material identified by Chemical Abstracts Registry Number (CAS#) 67762-38-3; and
(d) one or more alkyl esters selected from the group consisting of hexadecanoic methyl ester, octadecanoic methyl ester, 9-octadecenoic methyl ester (Z), 9,12-octadecandienoic methyl ester (Z,Z), and 9,12,15 octadecatrienoic methyl ester (9Z,12Z,15Z).

21. The method of claim 15, wherein the composition comprises from 10 to 40% by weight of the herbicidal agent selected from the group consisting of (i), (ii), (iii), (iv), (v), (vi), (vii), (viii), (ix), and (x):
(i) one or more acids selected from the group consisting of hexanoic acid, octanoic acid, decanoic acid, and dodecanoic acid;
(ii) one or more methyl esters selected from the group consisting of methyl hexanoate, methyl octanoate, methyl decanoate, and methyl dodecanoate;
(iii) material identified by Chemical Abstracts Registry Number (CAS#) 67762-36-1;
(iv) methyl esters of material identified by Chemical Abstracts Registry Number (CAS#) 67762-36-1;
(v) one or more acids selected from the group of acids consisting of octanoic acid and decanoic acid;
(vi) one or more methyl esters selected from the group consisting of methyl octanoate and methyl decanoate;
(vii) one or more carboxylic acids selected from the group consisting of hexanoic acid, heptanoic acid, octanoic acid, nonanoic acid, decanoic acid, undecanoic acid, and dodecanoic acid;
(viii) one or more methyl esters selected from the group consisting of methyl hexanoate, methyl heptanoate, methyl octanoate, methyl nonanoate, methyl decanoate, methyl undecanoate, and methyl dodecanoate;
(ix) one or more ethyl esters selected from the group consisting of ethyl hexanoate, ethyl octanoate, ethyl decanoate, and ethyl dodecanoate;
(x) one or more propyl esters selected from the group consisting of propyl hexanoate, propyl octanoate, propyl decanoate, and propyl dodecanoate;
from 10 to 40% by weight the carrier selected from the group consisting of (a), (b), (c), and (d):
(a) soybean oil methyl ester;
(b) material identified by Chemical Abstracts Registry Number (CAS#) 67784-80-9;
(c) material identified by Chemical Abstracts Registry Number (CAS#) 67762-38-3; and
(d) one or more alkyl esters selected from the group consisting of hexadecanoic methyl ester, octadecanoic methyl ester, 9-octadecenoic methyl ester (Z), 9,12-octadecandienoic methyl ester (Z,Z), and 9,12,15 octadecatrienoic methyl ester (9Z,12Z,15Z); and
from 10 to 60% by weight of water; from 10 to 40% by weight of cyclomethicone; from 0.05 to 5% by weight of lauric acid; from 0.05 to 5% by weight of olefin sulfanate; from 0.05 to 5% by weight of pegylated castor oil; from 0.05 to 5% by weight of cedar oil; from 0.05 to 5% by weight of citric acid; from 0.05 to 5% by weight of lemon grass oil; and from 0.05 to 5% by weight of benzoic acid, and wherein weight percents of all ingredients total to 100 weight percent.

22. A method of killing unwanted plants by applying to said plants an herbicidal composition comprising at least one component selected from among (A), (B) and (C):
(A) acids selected from the group consisting of hexanoic acid, heptanoic acid, octanoic acid, nonanoic acid, decanoic acid, undecanoic acid, and dodecanoic acid;
(B) acids selected from the group consisting of hexanoic acid, octanoic acid, decanoic acid, and dodecanoic acid; and
(C) material identified by Chemical Abstracts Registry Number (CAS#) 67762-36-1.

23. A method of controlling the growth of unwanted plants in a locus containing unwanted and desired plants, said method comprising applying to the locus a composition comprising (i) an herbicidal agent and (ii) a carrier comprising mono alkyl esters of long chain fatty acids, wherein the composition comprises an amount of said herbicidal agent that is sufficient to kill the unwanted plants but insufficient to kill the desired plants.
